(19) United States
(12) Patent Application Publication
(10) Pub. No.: US 2013/0177166 A1
(43) Pub. Date: Jul. 11, 2013

(54) HEAD-RELATED TRANSFER FUNCTION (HRTF) SELECTION OR ADAPTATION BASED ON HEAD SIZE

(71) Applicants: Markus Agevik, Malmo (SE); Martin Nystrom, Horja (SE)

(72) Inventors: Markus Agevik, Malmo (SE); Martin Nystrom, Horja (SE)

(73) Assignee: SONY ERICSSON MOBILE COMMUNICATIONS AB, Lund (SE)

(21) Appl. No.: 13/823,243

(22) PCT Filed: May 27, 2011
(86) PCT No.: PCT/IB2011/052345

§ 371 Date: Mar. 14, 2013

(51) Int. Cl. H04R 3/00

(52) U.S. Cl. CPC H04R 3/00
USPC 381/74

(57) ABSTRACT

A method includes determining a user's head size, forwarding information associated with the user's head size to a processing device. The method also includes identifying, by the processing device, a head-related transfer function (HRTF) associated with the user's head size or modifying, by the processing device, a HRTF based on the user's head size. The method further includes applying the identified HRTF or modified HRTF to audio signals to produce output signals, and forwarding the output signals to first and second speakers.

### TECHNICAL FIELD OF THE INVENTION

The invention relates generally to audio technology and, more particularly, to head-related transfer functions.

### DESCRIPTION OF RELATED ART

Audio devices having a pair of speakers, may realistically emulate three-dimensional (3D) audio sound emanating from sources located in different places. For example, digital signal processing devices may control the output to the speakers to produce natural and realistic audio sound effects.

### SUMMARY

According to one aspect, a method may comprise determining a user's head size, forwarding information associated with the user's head size to a processing device, and at least one of identifying, by the processing device, a HRTF associated with the user's head size, or modifying, by the processing device, a HRTF based on the user's head size. The method also includes applying the identified HRTF or modified HRTF to audio signals to produce output signals, and forwarding the output signals to first and second speakers.

Additionally, the at least one of identifying or modifying comprises identifying a HRTF associated with the user's head size, and identifying a HRTF may comprise accessing a memory storing a plurality of HRTFs, and identifying a first one of the plurality of HRTFs corresponding to the user's head size.

Additionally, the memory may be configured to at least one of store HRTFs corresponding to a small head size, a medium head size and a large head size, store HRTFs corresponding to a plurality of different head circumferences, or store HRTFs corresponding to a plurality of different head diameters.

Additionally, the method may further comprise determining a second user's head size, forwarding information associated with the second user's head size to the processing device; and accessing the memory to determine whether one of the plurality of HRTFs corresponds to the second user's head size.

Additionally, the method may further comprise at least one of generating a HRTF based on the second user's head size, in response to determining that none of the plurality of HRTFs corresponds to the second user's head size, or modifying one of the plurality of HRTFs based on the second user's head size, in response to determining that none of the plurality of HRTFs corresponds to the second user's head size.

Additionally, the determining a user's head size may comprise estimating, by a sensor located on a headset worn by the user, the user's head size.

Additionally, the estimating may comprise measuring, by the sensor, a strain or degree of bend of a portion of the headset.

Additionally, the method may further comprise determining the user's ear positions, and the identifying a HRTF may further comprise identifying the HRTF based on the user's ear positions.

Additionally, the method may further comprise providing a user interface for receiving an input for selecting one of a plurality of head sizes, selecting an HRTF corresponding to the selected head size, and applying the selected HRTF to audio signals to be output to first and second speakers.

Additionally, the determining a user's head size may be performed by at least one of a headset device, a neckband device, an eyeglass device or a headphones device.

According to another aspect, a device comprises a memory configured to store a plurality of HRTFs, each of the HRTFs being associated with a different head size. The device also includes processing logic configured to receive head size information associated a user, at least one of identify a first HRTF associated with the received head size information, generate a first HRTF based on the received head size information or modify an existing HRTF to provide a first HRTF based on the received head size information, and apply the first HRTF to audio signals to produce output signals. The device also includes a communication interface configured to forward the output signals to first and second speakers configured to provide sound to the user's left and right ears.

Additionally, the plurality of HRTFs may include at least HRTFs corresponding to a small head size, a medium head size and a large head size.

Additionally, the processing logic may be further configured to receive head size information associated with a second user, and determine whether one of the plurality of HRTFs stored in the memory corresponds to the second user's head size.

Additionally, the processing logic may be further configured to at least one of generate a HRTF based on the second user's head size, in response to determining that none of the plurality of HRTFs corresponds to the second user's head size, or modify one of the plurality of HRTFs based on the second user's head size, in response to determining that none of the plurality of HRTFs corresponds to the second user's head size.

Additionally, the communication interface may be configured to receive the plurality of HRTFs from an external device, and the processing logic is configured to store the HRTFs received from the external device in the memory.

Additionally, the device may further comprise a headset comprising the first and second speakers.

Additionally, the device may comprise a mobile terminal.

According to still another aspect, a device comprises a right ear speaker, a left ear speaker, and at least one sensor. The at least one sensor is configured to measure at least one parameter associated with a user of the device. The device also includes a processor configured to estimate head size of the user based on the at least one parameter, and forward head size related information to a processing device to identify a head related transfer function (HRTF) to apply to audio signals provided to the right ear speaker and left ear speaker.

Additionally, the at least one sensor may be configured to measure a degree of strain, bend or deflection exerted on a portion of the device.

Additionally, the device may comprise the processing device, wherein the processing device is configured to at least one of identify the HRTF from a plurality of HRTFs based on the head size related information, generate the HRTF based on the head size related information or modify an existing HRTF to provide the HRTF based on the head size related information.

### BRIEF DESCRIPTION OF THE DRAWINGS

The accompanying drawings, which are incorporated in and constitute part of this specification, illustrate one or more embodiments described herein and, together with the description, explain the embodiments. In the drawings:

FIGS. 1A and 1B illustrate concepts described herein;

FIG. 2 illustrates an exemplary system in which concepts described herein may be implemented;

FIGS. 3A and 3B illustrate an exemplary embodiment associated with measuring the head size of a user;

FIGS. 4A and 4B illustrate a sensor used to measure head size of a user in one exemplary implementation;

FIGS. 5A and 5B illustrate another sensor used to measure head size of a user in another exemplary implementation;

FIG. 6 is a block diagram of exemplary components of the user device of FIG. 2;

FIG. 7 is a block diagram of functional components implemented in the user device of FIG. 2 according to an exemplary implementation;

FIG. 8 is an exemplary table stored in the HRTF database of FIG. 7 according to an exemplary implementation;

FIG. 9 is a block diagram of functions components implemented in the HRTF device of FIG. 2 in accordance with an exemplary implementation; and

FIG. 10 is a flow diagram illustrating exemplary processing by components of the system of FIG. 2 in accordance with an exemplary implementation.

### DETAILED DESCRIPTION

The following detailed description refers to the accompanying drawings. The same reference numbers in different drawings may identify the same or similar elements. As used herein, the term “body part” may include one or more other body parts.

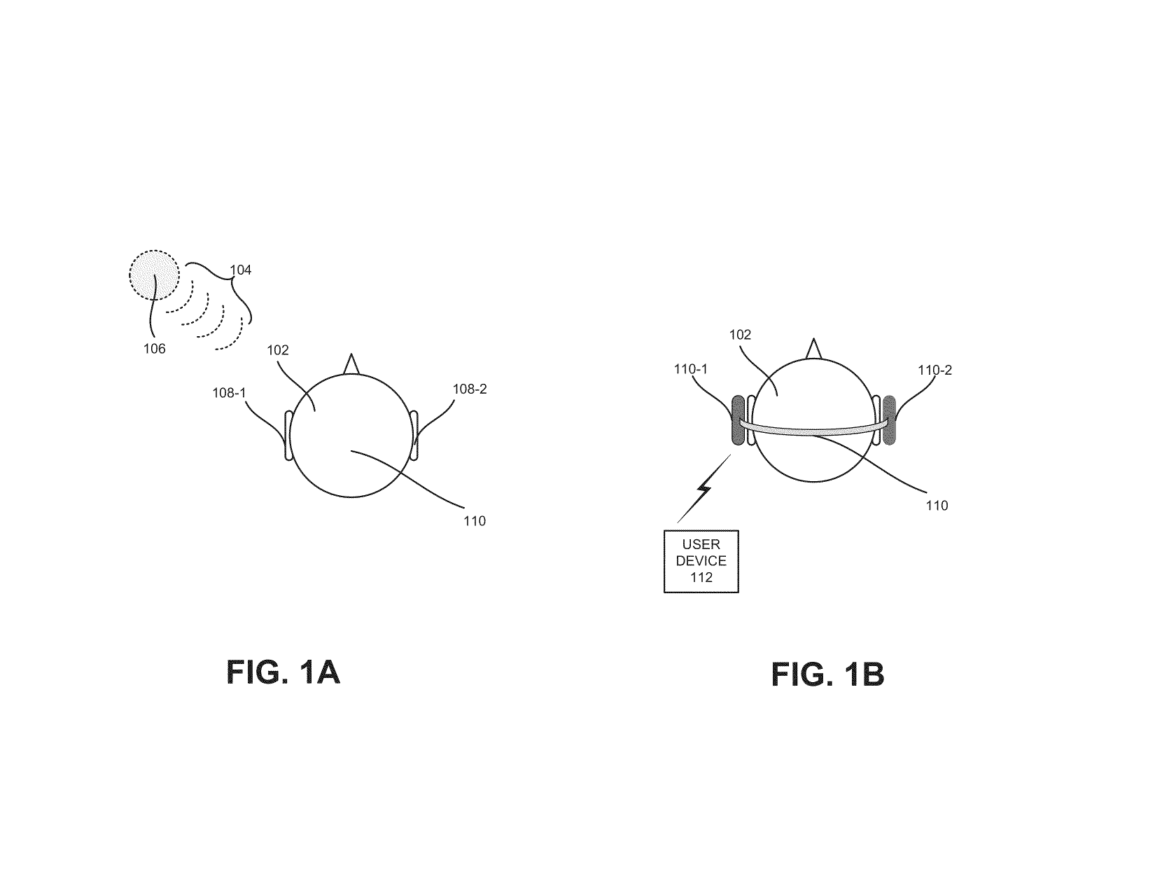

FIGS. 1A and 1B illustrates concepts described herein. FIG. 1A shows a user 102 listening to a sound 104 that is generated from a source 106. As shown, user 102's left ear 108-1 and right ear 108-2 may receive different portions of sound waves from source 106 for a number of reasons. For example, ears 108-1 and 108-2 may be at unequal distances from source 106, as illustrated in FIG. 1A. As a result, a sound wave may arrive at ears 108-1 and 108-2 at different times. As another example, sound 104 arriving at right ear 108-2 may have traveled a different path than the corresponding sound at left ear 108-1 due to different spatial geometry of objects (e.g., the direction in which right ear points is different from that of the left ear, user 102's head obstructs right ear 108-2, etc.). More specifically, for example, portions of sound 104 arriving at right ear 108-2 may diffract around the user's head 102 before arriving at ear 108-2. These differences of sound detection may give the user the impression that the source of the sound being heard is from a particular distance and or direction. Natural hearing normally detects variation of a sound source's 106 directions and distances.

Assume that the extent of acoustic degradations from source 106 to left ear 108-1 and right ear 108-2 are encapsulated in or summarized by head-related transfer functions H_{L}(ω) and H_{R}(ω), respectively, where w is frequency. Then, assuming that sound 104 at source 106 is X(ω), the sounds arriving at each of ears 108-1 and 108-2 can be expressed as H_{L}(ω). X(ω) and H_{R}(ω)-X(ω).

FIG. 1B shows a pair of earphones 110-1 and 110-2 that each include speakers that are controlled by a user device 112 within a sound system. Assume that user device 112 causes earphones 110-1 and 110-2 to generate signals G_{L}(ω)-X(ω) and G_{R}(ω)-X(ω), respectively, where G_{L}(ω) and G_{R}(ω) are approximations to H_{L}(ω) and H_{R}(ω). By generating G_{L}(ω)·X(ω) and G_{R}(ω)·X(ω), user device 112 and earphones 110-1 and 110-2 may emulate sound that is generated from source 106. The more accurately that G_{L}(ω) and G_{R}(ω) approximate H_{L}(ω) and H_{R}(ω), the more accurately user device 112 and earphones 110-1 and 110-2 may emulate sound source 106.

In some implementations, the sound system may obtain G_{L}(ω) and G_{R}(ω) by applying a finite element method (FEM) to an acoustic environment that is defined by the boundary conditions that are specific to a particular individual. Such individualized boundary conditions may be obtained by the sound system by deriving 3D models of user 102's head based on, for example, the size of user 102's head. In other implementations, the sound system may obtain G_{L}(ω) and G_{R}(ω) by selecting one or more pre-computed HRTFs based on the 3D models of user 102's head, including user 102's head size and the distance between user 102's ears. As a result, the individualized HRTFs may provide better sound experience than a generic HRTF.

For example, the HRTF attempts to emulate spatial auditory environments through filtering the sound source before it is provided to the use's left and right ears to emulate natural hearing. The closer that the HRTF matches the individual user's physical attributes (e.g. head size, ear positions etc.), the greater or more realistic the emulated spatial auditory experience will be for the user, as described in more detail below.

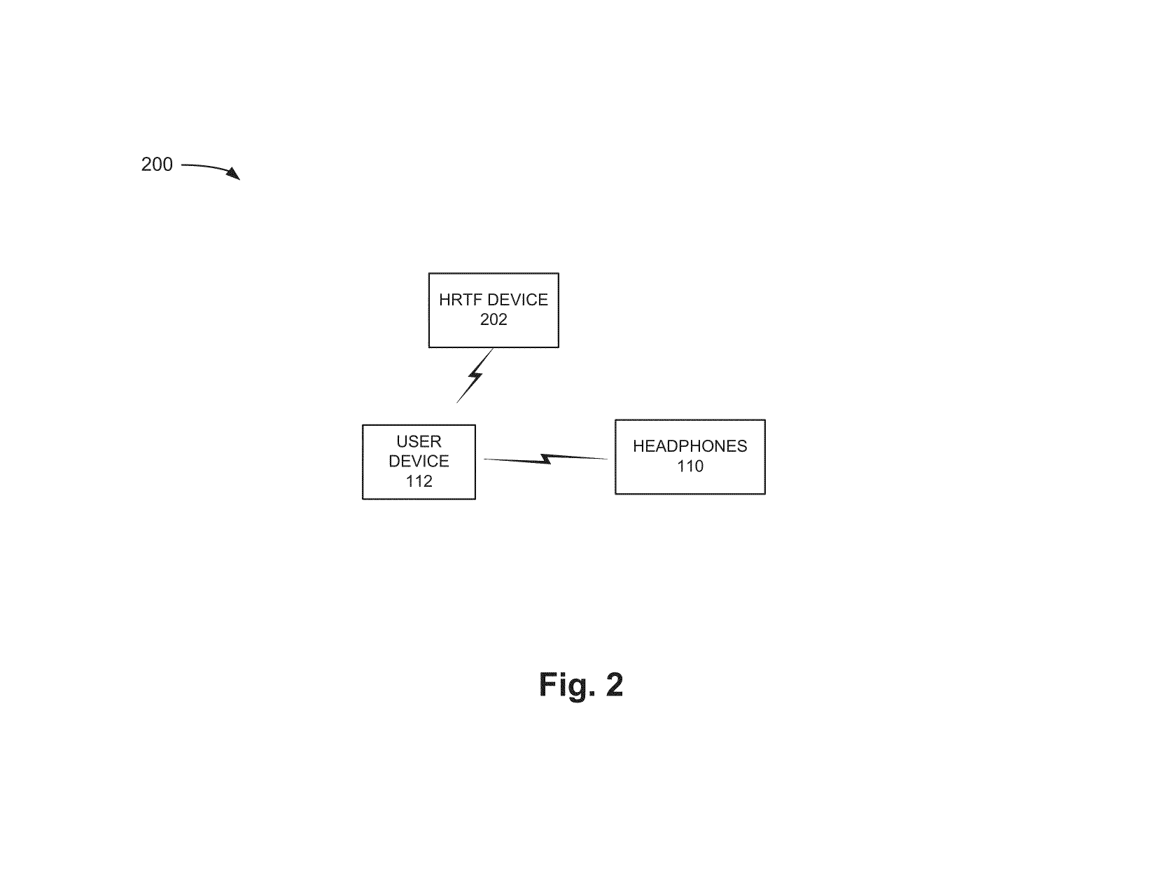

FIG. 2 illustrates an exemplary system 200 in which concepts described herein may be implemented. Referring to FIG. 2, system 200 includes headphones 110 (also referred to herein as headset 110), user device 112 and HRTF device 202. Devices in system 200 may communicate with each other via wireless, wired, or optical communication links. User device 112 may include a personal computer, a tablet computer, a laptop computer, a netbook, a cellular or mobile telephone, a smart phone, a personal communications system (PCS) terminal that may combine a cellular telephone with data processing and/or data communications capabilities, a personal digital assistant (PDA) that includes a telephone, a music playing device (e.g., an MP3 player), a gaming device or console, a peripheral (e.g., wireless headphone); a digital camera, a display headset (e.g., a pair of augmented reality glasses); or another type of computational or communication device.

Headphones 110 may be an adjustable headset that adjusts to the head size of various users. Headphones 110 may include left ear and right ear speakers to generate sound waves in response to the output signal received from user device 112. For example, headphones 110 may include in-ear speakers, over-the ear speakers, ear buds, etc. Headphones 110 may also include one or more sensors to determine the head size of a user currently wearing headphones 110. The head size information may be provided to user device 112 to customize the audio output provided to headphones 110, as described in more detail below.

User device 112 may receive information associated with a user, such as a user's head size. Based on the head size, user device 112 may obtain 3D models that are associated with the user (e.g., a 3D model of the user's head, including the user's ears). User device 112 may send the 3D models (i.e., data that describe the 3D models) to HRTF device 202. In some implementations, the functionalities of HRTF device 202 may be integrated within user device 112.

HRTF device 202 may receive, from user device 112, parameters that are associated with a user, such as the user's head size, ear locations, distance between the user's ears, etc. Alternatively, HRTF device 202 may receive 3D model information corresponding to the user's head size. HRTF device 202 may select, derive, or generate individualized HRTFs for the user based on the received parameters (e.g., head size). HRTF device 202 may send the individualized HRTFs to user device 112.

User device 112 may receive HRTFs from HRTF device 202 and store the HRTFs in a database. In some implementations, user device 112 may pre-store a number of HRTFs based on different head sizes. User device 112 may dynamically select a particular HRTF based on, for example, the user's head size and apply the selected HRTF to an audio signal (e.g., from an audio player, radio, etc.) to generate an output signal. User device 112 may provide the output signal to headphones 110.

For example, user device 112 may include an audio signal component that generates audio signals to which user device 112 may apply a customized HRTF. User device 112 may then output the audio signals to headphones 110.

Depending on the implementation, system 200 may include additional, fewer, different, and/or a different arrangement of components than those illustrated in FIG. 2. For example, in one implementation, a separate device (e.g., an amplifier, a receiver-like device, etc.) may apply a HRTF generated from HRTF device 202 to an audio signal to generate an output signal. The device may send the output signal to headphones 110. In another implementation, system 200 may include a separate device for generating an audio signal to which a HRTF may be applied (e.g., a compact disc player, a digital video disc (DVD) player, a digital video recorder (DVR), a radio, a television, a set-top box, a computer, etc.). Also, system 200 may include various devices (e.g., routers, bridges, switches, gateways, servers, etc.) that allow the devices to communicate with each other.

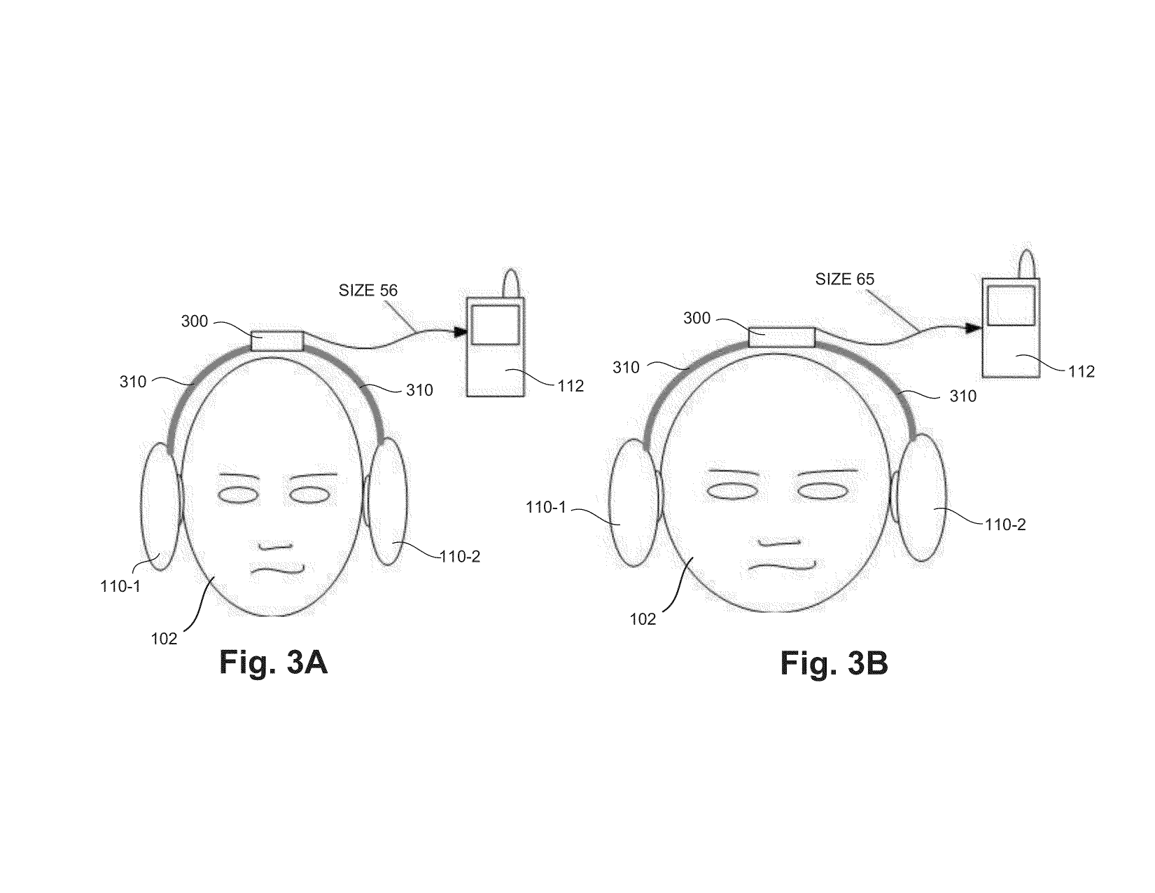

FIGS. 3A and 3B illustrate an exemplary adjustable headset 110 consistent with implementations described herein. In the implementation illustrated in FIGS. 3A and 3B, headset 110 may be an over the head type headset in which the portion of headset connecting the ear pieces 110-1 and 110-2 (labeled 310 in FIG. 3A) abuts 102's head or is located adjacent the upper circumference of user 102's head. In other implementations, headset 110 may be implemented via various other forms/types, such as a neckband type headset, an ear loop headset, etc. In each case, headset 110 may be adjustable for accommodating a variety of different sized user heads and ear positions. Headset 110 may also be wired, or wireless. That is, headset 110 may communicate with user device 112 via wired or wireless protocols.

Referring to FIG. 3A, headset 110 may include ear pieces 110-1 and 110-2, sensor 300 and portion 310 that connect ear pieces 110-1 and 110-2 to each other. Ear pieces 110-1 and 110-2 may each include a speaker that provides sound to user 102. The speakers in earpieces 110-1 and 110-2 may generate sound for user 102's left and right ears in response to output signals received from user device 112.

Portion 310 may be made of plastic, a composite or some other material and may be adjustable to the head size of user 102. Sensor 300 may be connected to portion 310 and may determine the head size associated with user 102. For example, in FIG. 3A, sensor 300 may determine the circumference of user 102's head to be approximately 56 centimeters (cm). Sensor 300 may communicate this head size information to user device 112. In FIG. 3B, user 102 has a larger head size than in FIG. 3A. In this case, sensor 300 may determine the circumference of user 102's head to be approximately 65 cm, and sensor 300 communicates this information to user device 112. In some implementations, sensor 300 may include a display for displaying a numeric value associated with the user's head size.

As described above, sensor 300 may dynamically determine the head size of user 102. For example, headset 110 may include an adjustment mechanism (not shown in FIG. 3) that allows headset 110 to be adjusted to accommodate the various widths and shapes of user 102's head, as well as the different positions of the user 102's ears. Accordingly, headset 102 may accommodate a variety of head sizes and ear positions. The adjustment mechanism may include a single adjustment mechanism for accommodating both the head size and ear positions. Alternatively, the adjustment mechanism may include multiple adjustment mechanisms for adjusting the size of headset 110.

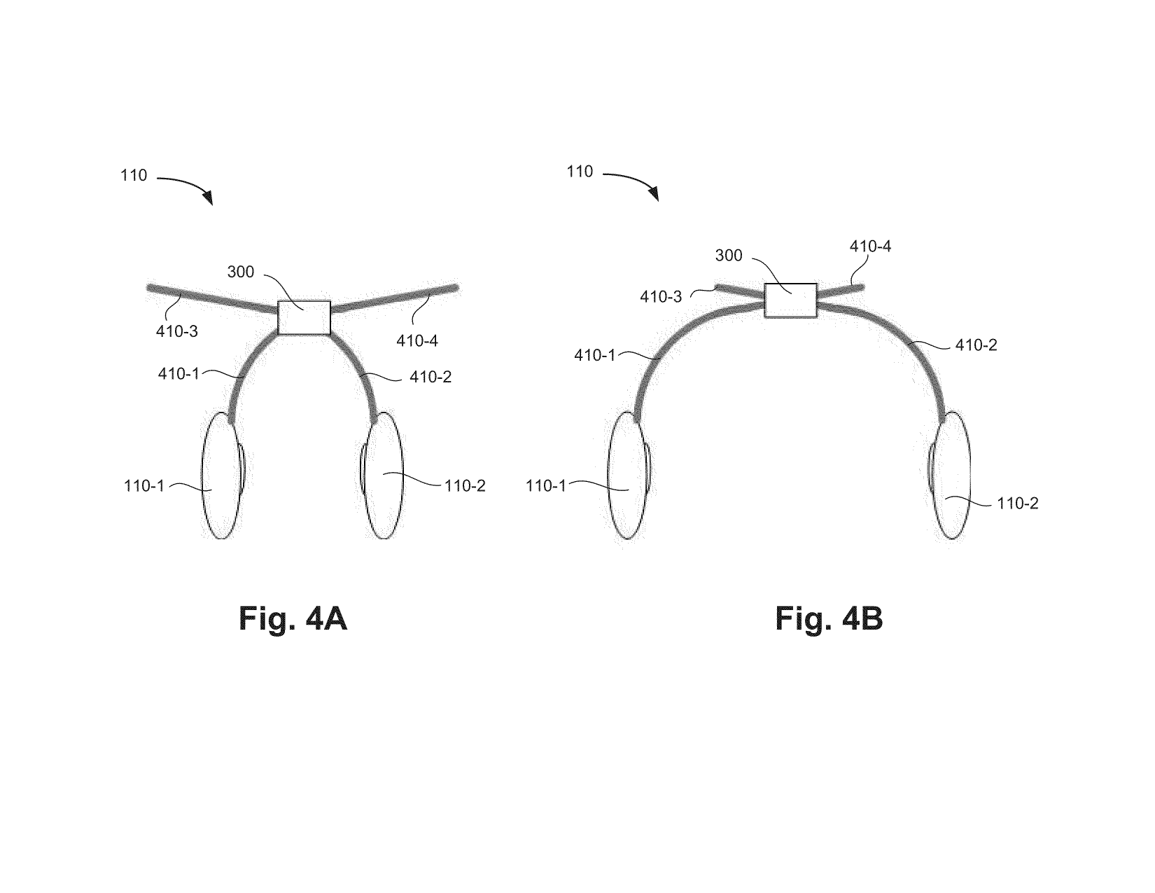

FIGS. 4A and 4B depict an exemplary implementation in which the adjustment mechanism is a sliding mechanism and sensor 300 includes a sliding sensor that determines the head size based on the location of sensor 300 with respect to portions 410-1, 410-2, 410-3 and 410-4. For example, the portions of headset 110 connecting earpieces 110-1 and 110-2 may include a number of segments/portions labeled 410-1, 410-2, 410-3 and 410-4. Sensor 300 may determine the size of the user's head based on the linear location of sensor 300 with respect to one or more of segments 410-1, 410-2, 410-3 and 410-4.

For example, sensor 300 may sense the location at which one or more segments 410-1 through 410-4 contact sensor 300. Sensor 300 may then use this information to determine the size of a user's head (i.e., the user wearing headset 110). For example, FIG. 4A illustrates a scenario when segments 410-1 and 410-2 are relatively short as compared to segments 410-1 and 410-2 in FIG. 4B. Correspondingly, segments 410-3 and 410-4 in FIG. 4A are much longer than segments 410-3 and 410-4 in FIG. 4B. Sensor 300 may then determine the size of the user's head based on the length of one or more of segments 410-1 through 410-4.

As one example, segment 410 may include embedded information located at various points of segment 410 that is readable by sensor 300. In this implementation, sensor 300 may read the embedded information and identify head size based on where sensor 300 is located with respect to one or more of segments cables 410-1 through 410-4.

Alternatively, sensor 300 may determine the head size of user 102 based on the strain or the degree of bend in, for example, segment 410-1 or 410-2. As an example, segment 410-1 may have a steeper or greater degree of bend in FIG. 4A than the more gradual degree of bend of segment 410-1 in FIG. 4B. Sensor 300 may measure the degree of bend, strain or deflection in segment 410-1 (or 410-2) and correlate the degree of bend, strain or deflection to a head size. For example, sensor 300 may store a table that correlates the degree of bend or strain in segment 410-1 (or 410-2) to a head size.

In each case, based on the example shown in FIG. 4A, sensor 300 may determine the circumference of the head size of the user (not shown) wearing headset 110 to be approximately 56 cm. Similarly, in FIG. 4B, sensor 300 may determine the head size of the user (not shown) wearing headset 110 to be approximately 65 cm.

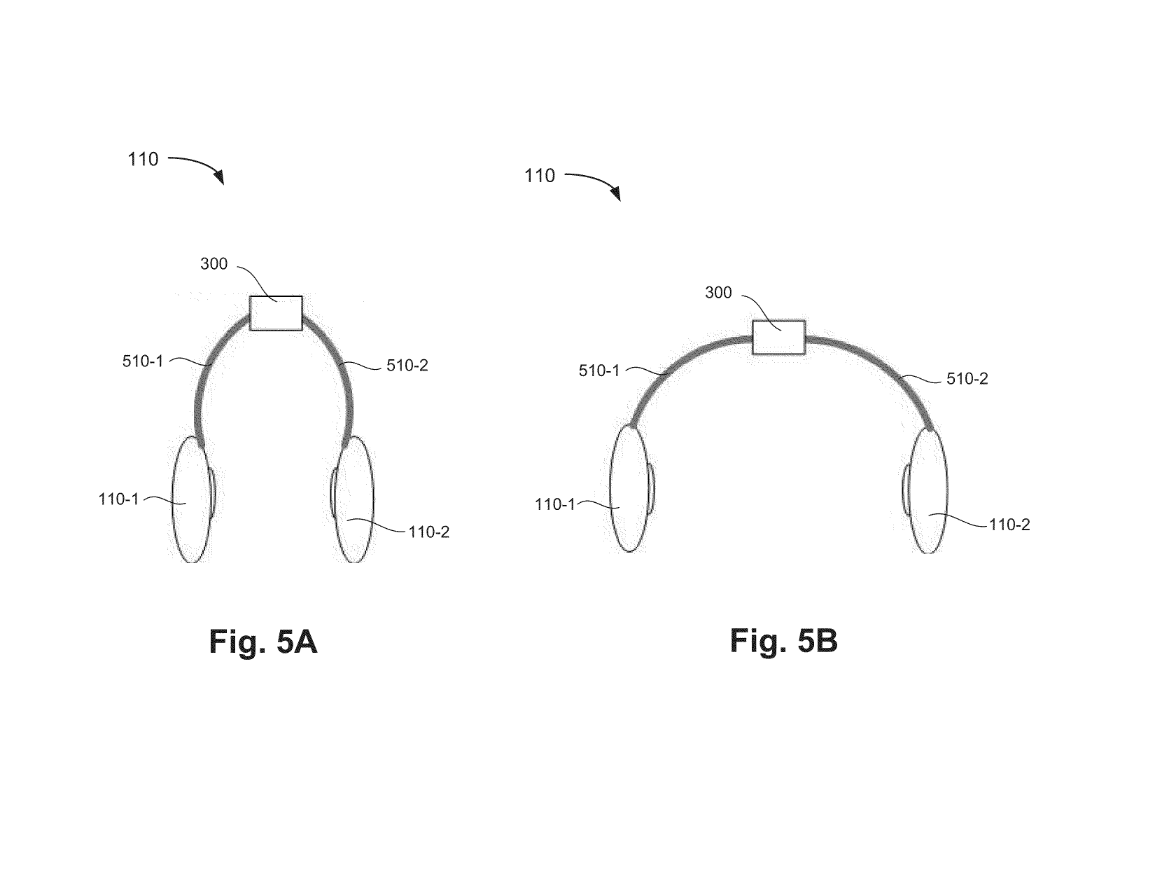

As another example, FIGS. 5A and 5B depict an exemplary implementation in which sensor 300 includes a bending sensor that determines the head size based on the degree of bend, strain or deflection associated with segments 510-1 and 510-2 connected to ear pieces 110-1 and 110-2 in a manner similar to that described above with respect to FIGS. 4A and 4B. For example, referring to FIG. 5A, headset 110 includes segments 510-1 and 510-2 connecting the two ear pieces 110-1 and 110-2. Bending sensor 300 may estimate the size of the user's head based on the degree of bend, strain or deflection associated with segment 510-1 and/or 510-2 Implementations described herein may use any number of methods for measuring strain/bend/deflections, such as the Castigliano method, the Macaulay method, the direct stiffness method, etc. In each case, the degree of bend, strain or deflection may be correlated to head size information.

Referring to FIG. 5A, the degree of bend of segments 510-1 and 510-2 is greater than the degree of bend of segments 510-1 and 510-2 in FIG. 5B. In this case, bending sensor 300 may determine the head size of the wearer of headset 110 in FIG. 5A to be smaller than the head size of the wearer of headset 110 in FIG. 5B based on the greater degree of bend. For example, sensor 300 may correlate the degree of bend in cable 510-1 and/or 510-2 and determine the head size of the user (not shown) wearing headset 110 in FIG. 5A to be approximately 56 cm. Similarly, sensor 300 may determine the head size of the user (not shown) wearing headset 110 in FIG. 5B to be approximately 65 cm.

FIGS. 3A-5B illustrate an exemplary sensor 300 used to measure or estimate a user's head size. In other implementations, other types of sensors and/or techniques, such as resistive sensors, capacitive sensors, Gray code techniques, etc., may be used to measure/estimate a user's head size. Still further, in other implementations, in-ear monitors and/or sensors may be used to measure/estimate a user's head size.

In each case, once the user's head size and/or ear positions are determined, a corresponding optimized individual HRTF for that user may be determined For example, user device 112 and/or HRTF device 202 may receive head size information and dynamically provide an appropriate HRTF for that particular user, as described in more detail below.

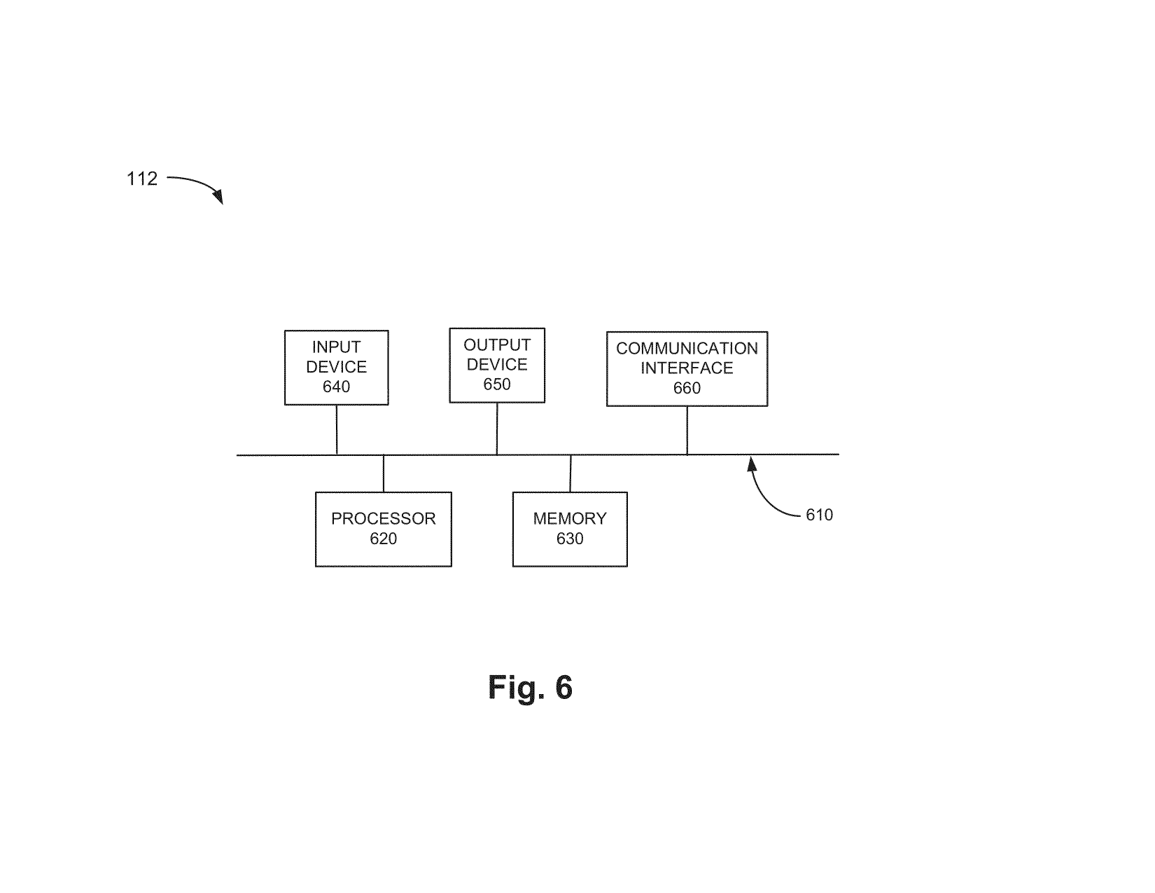

FIG. 6 is a diagram illustrating components of user device 112 according to an exemplary implementation. HRTF device 202 and headset 110 may be configured in a similar manner. User device 112 may include bus 610, processor 620, memory 630, input device 640, output device 650 and communication interface 660. Bus 610 permits communication among the components of user device 112 and or adjustable headset 110. One skilled in the art would recognize that user device 112 may be configured in a number of other ways and may include other or different elements. For example, user device 112 may include one or more modulators, demodulators, encoders, decoders, etc., for processing data.

Processor 620 may include a processor, microprocessor, an application specific integrated circuit (ASIC), field programmable gate array (FPGA) or other processing logic. Processor 620 may execute software instructions/ programs or data structures to control operation of user device 112.

Memory 630 may include a random access memory (RAM) or another type of dynamic storage device that stores information and instructions for execution by processor 620; a read only memory (ROM) or another type of static storage device that stores static information and instructions for use by processor 620; a flash memory (e.g., an electrically erasable programmable read only memory (EEPROM)) device for storing information and instructions; a hard disk drive (HDD); and/or some other type of magnetic or optical recording medium and its corresponding drive. Memory 630 may also be used to store temporary variables or other intermediate information during execution of instructions by processor 620. Instructions used by processor 620 may also, or alternatively, be stored in another type of computer-readable medium accessible by processor 620. A computer readable medium may include one or more memory devices.

Input device 640 may include mechanisms that permit an operator to input information to user device 112, such as a microphone, a keypad, control buttons, a keyboard (e.g., a QWERTY keyboard, a Dvorak keyboard, etc.), a gesture-based device, an optical character recognition (OCR) based device, a joystick, a touch-based device, a virtual keyboard, a speech-to-text engine, a mouse, a pen, a stylus, voice recognition and or biometric mechanisms, etc.

Output device 650 may include one or more mechanisms that output information to the user, including a display, a printer, one or more remotely located speakers, such as two or more speakers associated with headset 110, etc.

Communication interface 660 may include a transceiver that enables user device 112 to communicate with other devices and/or systems. For example, communication interface 660 may include a modem or an Ethernet interface to a LAN. Communication interface 660 may also include mechanisms for communicating via a network, such as a wireless network. For example, communication interface 660 may include one or more radio frequency (RF) transmitters, receivers and/or transceivers and one or more antennas for transmitting and receiving RF data via a network. Such a network may include a cellular network, a public switched telephone network (PSTN), a local area network (LAN), a wide area network (WAN), a wireless LAN, a metropolitan area network (MAN), personal area network (PAN), a Long Term Evolution (LTE) network, an intranet, the Internet, a satellite-based network, a fiber-optic network (e.g., passive optical networks (PONs)), an ad hoc network, any other network, or a combination of networks.

User device 112 may receive information from headset 110 and generate or identify one or more individualized HRTFs to be applied to audio signals output to headset 110. The individualized HRTFs may be dynamically computed, selected from among a number of pre-computed HRTFs, and or an augmented or modified HRTF which may be based upon a previously stored HRTF. In each case, the individualized HRTF may be applied to audio signals output to headset 110 to provide the desired audio sound effect.

User device 112 (or HRTF device 202) may perform these operations in response to their respective processors 620 executing sequences of instructions contained in a computer-readable medium, such as memory 630. Such instructions may be read into memory 630 from another computer-readable medium via, for example, communication interface 660. In alternative embodiments, hard-wired circuitry may be used in place of or in combination with software instructions to implement processes consistent with the invention. Thus, implementations described herein are not limited to any specific combination of hardware circuitry and software.

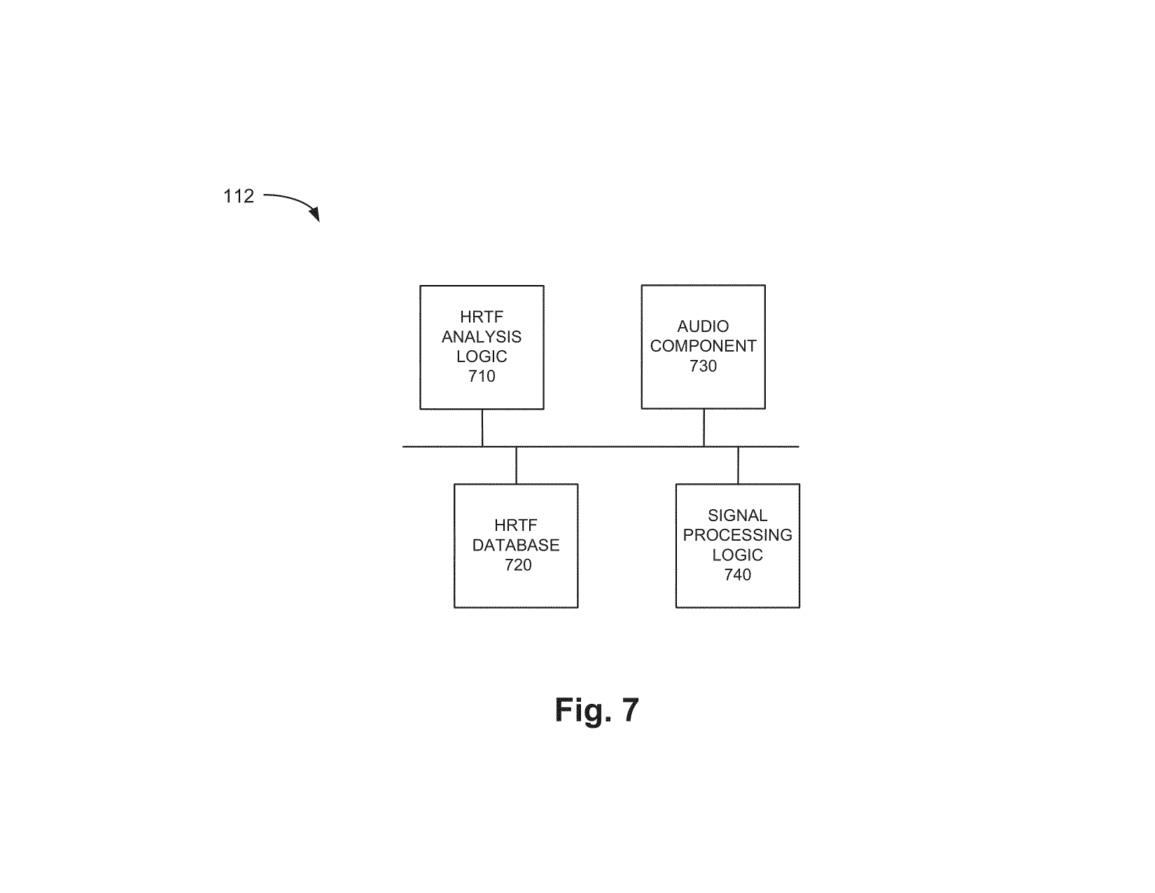

FIG. 7 is a block diagram of functional components of user device 112 in accordance with an exemplary implementation. Referring to FIG. 7, user device 112 may include HRTF analysis logic 710, HRTF database 720, audio component 730 and signal processing logic 740. All or some of the components illustrated in FIG. 7 may be implemented by processor 620 executing instructions stored in memory 630 of user device 112.

HRTF analysis logic 710 may obtain information from sensor 300 regarding the head size of a user currently wearing headset 110. In some implementations, HRTF analysis logic 710 may also receive ear position information from sensor 300, such as the distance between a user's ears, the location of the ear's with respect to the user's head (e.g., whether one ear is located higher on the user's head than the other ear). HRTF analysis logic 710 may select a particular HRTF based on the received information. In some implementations, HRTF analysis logic 710 may generate or augment pre-stored HRTF data based on information from sensors 300 and store the new or modified HRTF in HRFT database 720.

HRTF database 720 may receive HRTFs from another component of device (e.g., HRFT device 202, HRTF analysis logic 710, etc.) and store the HRTFs along with corresponding identifiers. In one implementation, the identifier may be based on head size.

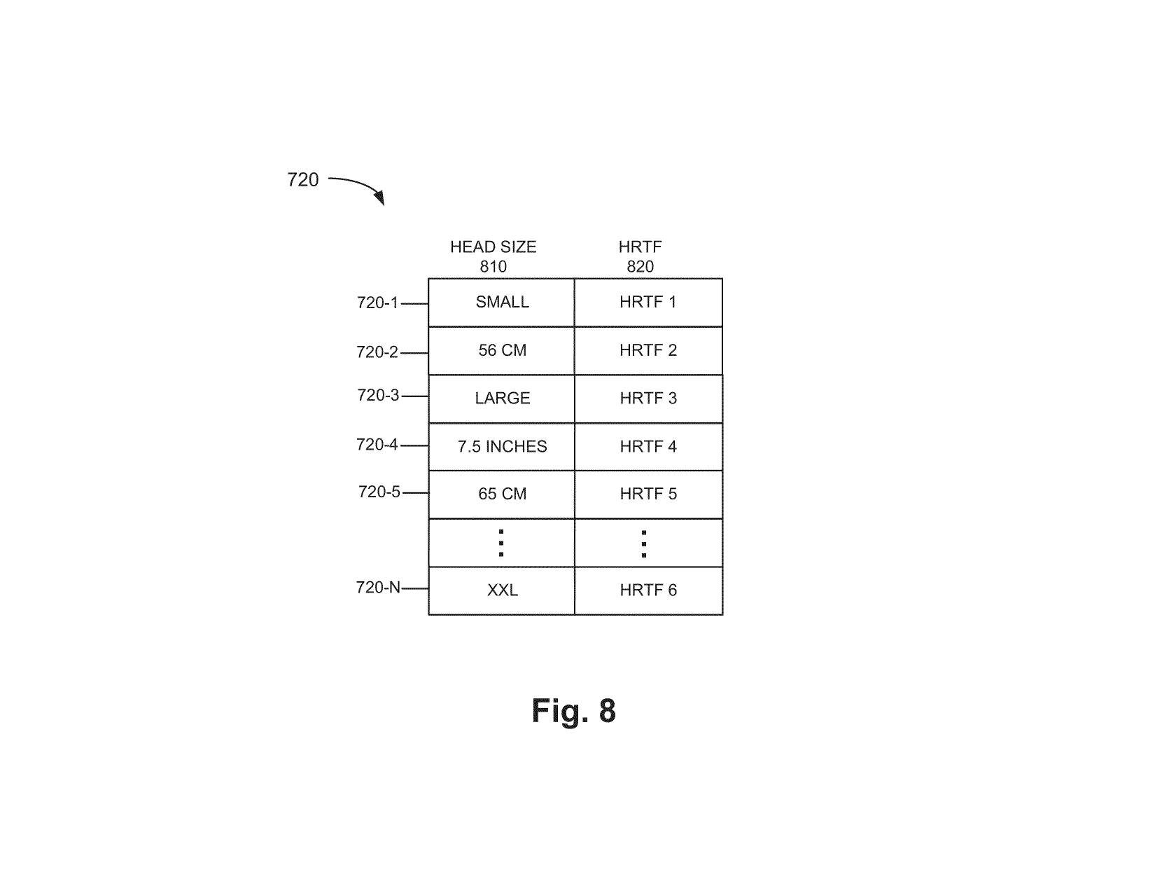

For example, FIG. 8 illustrates an exemplary HRTF database 720. Referring to FIG. 8, database 720 may include a head size field 810 and an HRTF field 820. Head size field 810 may include information corresponding to various head sizes measured by sensor 300. For example, entry 720-1 indicates a head size of “small,” entry 720-2 indicates a head size of 56 cm (i.e., circumference of 56 cm) and entry 720-3 indicates a head size of “large.” Entry 720-4 indicates a head size of 7.5 inches, which corresponds to the diameter of the user's head in inches, as opposed to the circumference in centimeters. Therefore, HRTF database 720 may include relative head size information (e.g., small, medium, large, extra large), head size circumference information in, for example, centimeters, and head size diameter information in, for example, inches. This may allow HRTF database 720 to be used in connection with different types of headsets that provide various types of head size information.

HRTF field 820 may include identifiers associated with the corresponding entry in field 810. For example, field 820 of entry 720-1 indicates “HRTF 1.” HRTF 1 may identify the particular HRTF to apply to audio signals output to a user with a measured “small” head size. Similarly, field 820 of entry 720-5 may identify HRTF 5. HRTF 5 may identify the particular HRTF to apply to audio signals output to a user with a head size of approximately 65 cm.

Audio component 730 may include an audio player, radio, etc. Audio component 730 may generate an audio signal and provide the signal to signal processing logic 740. In some implementations, audio component 730 may provide audio signals to which signal processing logic 740, which may apply a HRTF and/or other types of signal processing. In other instances, audio component 730 may provide audio signals to which signal processing logic 740 may apply only conventional signal processing.

Signal processing logic 740 may apply a HRTF retrieved from HRTF database 720 to an audio signal that is to be output from audio component 730 or a remote device, to generate an output audio signal. In some configurations (e.g., selected via user input), signal processing logic 740 may also apply other types of signal processing (e.g., equalization), with or without a HRTF, to the audio signal. Signal processing logic 740 may provide the output signal to another device, such as left and right ear speakers of headset 110, as described in more detail below.

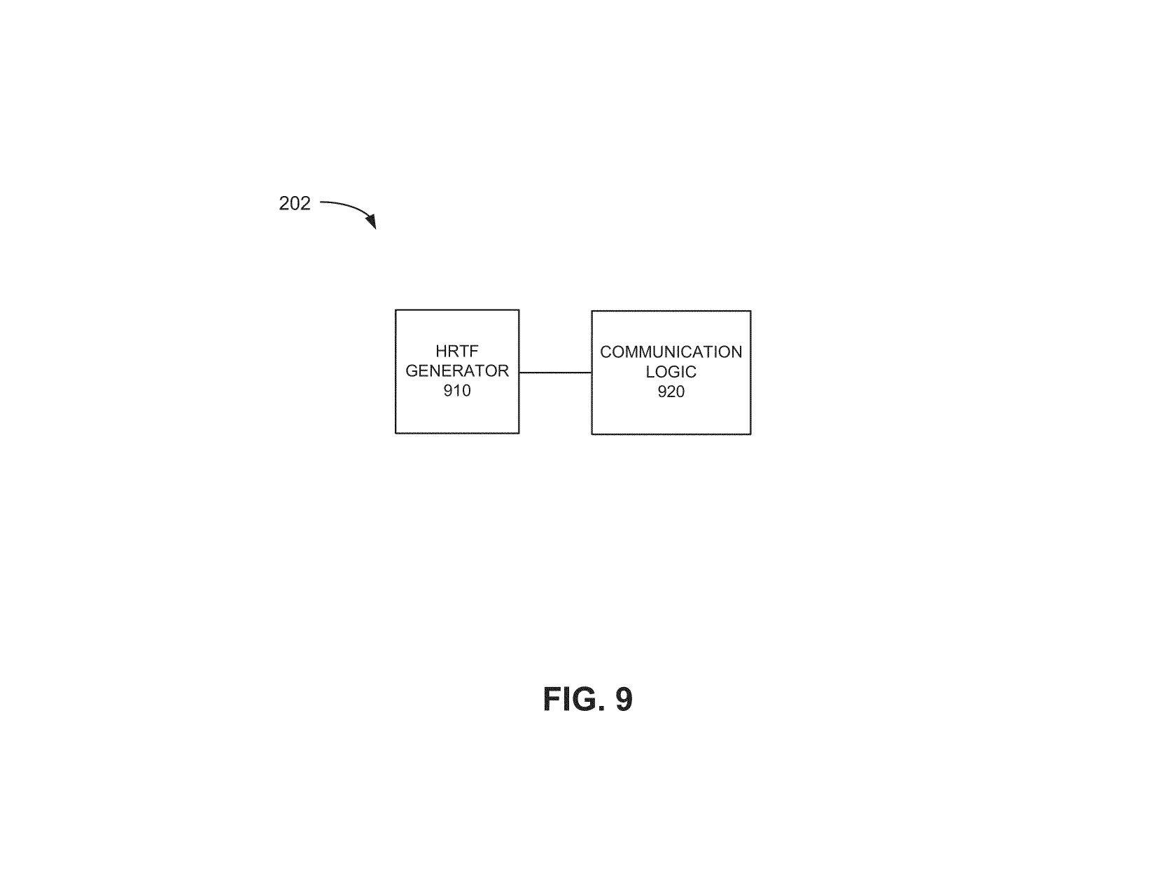

FIG. 9 is a functional block diagram of HRTF device 202. Referring to FIG. 9, HRTF device 202 may include HRTF generator 910 and communication logic 920. In some implementations, HRTF generator 910 may be implemented by processor 620 executing instructions stored in memory 630 of HRTF device 202. In other implementations, HRTF generator 910 may be implemented in hardware or a combination of hardware and software.

HRTF generator 910 may receive user-related information, such as head size information from user device 112, a 3-D model of a user's head, etc. In cases where HRTF generator 910 receives the head size information, as opposed to 3D models of a user's head, HRTF generator 910 may generate information pertaining to a 3D model based on the head size information.

HRTF generator 910 may select HRTFs, generate HRTFs, or obtain parameters that characterize the HRTFs based on information received from user device 112. In implementations or configurations in which HRTF generator 910 selects the HRTFs, HRTF generator 910 may include pre-computed HRTFs. HRTF generator 910 may use the received information (e.g., head size information provided by user device 112) to select one or more of the pre-computed HRTFs. For example, HRTF generator 910 may characterize a head size as large (as opposed to medium or small), having an egg-like shape (e.g., as opposed to circular). Based on these characterizations, HRTF generator 910 may select one or more of the pre-computed HRTFs.

In some implementations, HRTF generator 910 may receive additional or other information associated with a body part (e.g., ears) to further customize the generation or selection of HRTFs associated with various head sizes. Alternatively, HRTF generator 910 may refine or calibrate (i.e., optimize values of coefficients or parameters associated with the HRTF) the particular HRTFs based on information provided by user device 112.

As described above, in some implementations, HRTF generator 910 may compute the HRTFs or HRTF related parameters. In these implementations, HRTF generator 910 may apply, for example, a finite element method (FEM), finite difference method (FDM), finite volume method, and/or another numerical method, using the head size or 3D models of the head size as boundary conditions. This information may allow HRTF generator 910 to generate customized HRTFs corresponding to users' head sizes.

Once HRTF generator 910 generates HRTFs, HRTF generator 910 may send the generated HRTFs (i.e., or parameters that characterize transfer functions (e.g., coefficients of rational functions)) to another device (e.g., user device 112) via communication logic 920. For example, communication logic 920 may include one or more transceivers for communicating with communication interface 660 of user device 112 via wired or wireless mechanisms.

Depending on the implementation, HRTF device 202 may include additional, fewer, different, or different arrangement of functional components than those illustrated in FIG. 9. For example, HRTF device 202 may include an operating system, applications, device drivers, graphical user interface components, databases (e.g., a database of HRTFs), communication software, etc.

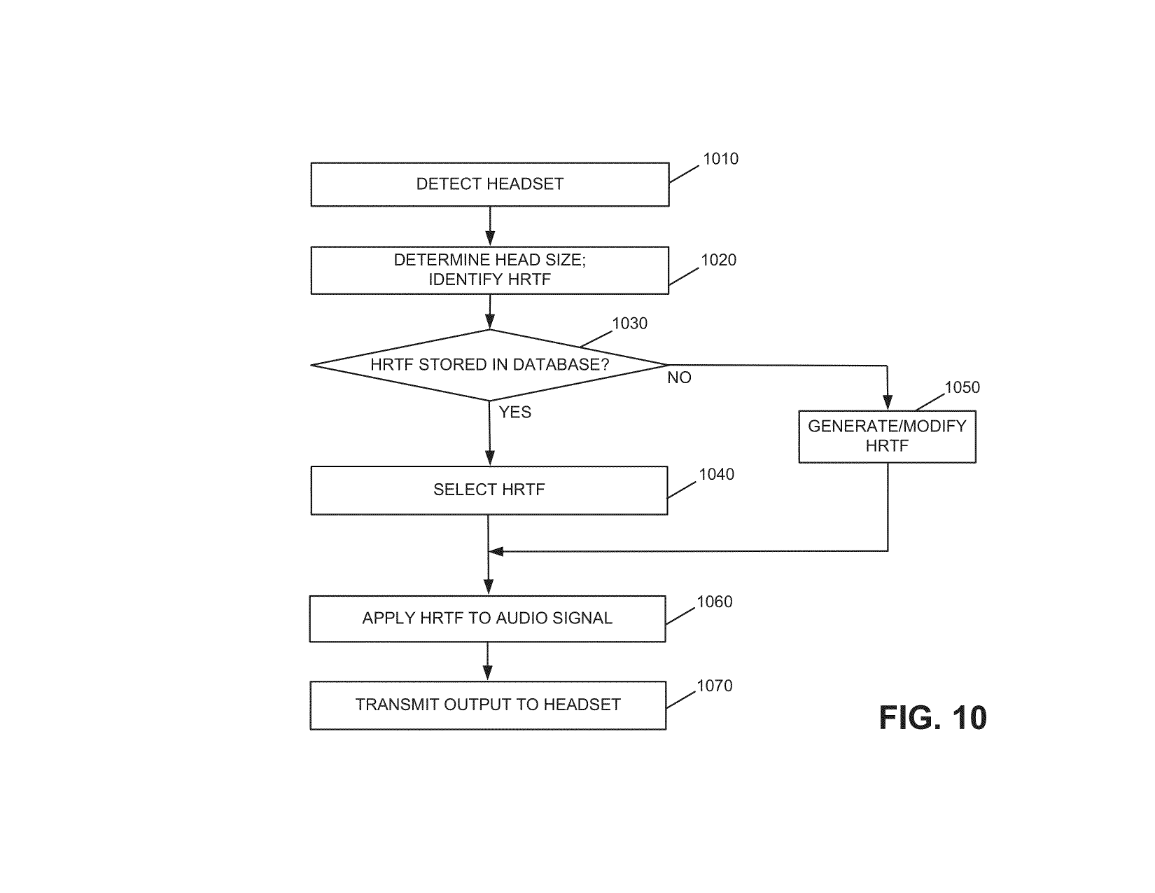

FIG. 10 is a flow diagram of an exemplary process for providing audio output to a user using an individualized HRTF. Processing may begin when a user activates or turns on headset 110 and/or user device 112. For example, a user may place headset 110 on his/her head and turn on user device 112 to listen to music. Sensor 300 may detect that headset is turned on (block 1010).

Upon activation and detection of the headset 110, sensor 300 may determine user 102's head size (block 1020). As described above, sensor 300 may be implemented in a number of different ways and may determine the head size based on the particular type of sensor. For example, as described above with respect to FIGS. 4A and 4B, sensor 300 may be a sliding sensor that estimates the user head size based on the location of one or more of segments 410-1 through 410-4 with respect to sensor 300, or via the strain/degree of bend or deflection associated with one or more of segments 410-1 through 410-4 of headset 110. Alternatively, as described above with respect to FIGS. 5A and 5B, sensor 300 may estimate the head size based on the degree of bend or strain associated with segments 510-1 and 510-2. In some implementations, headset 110 may use additional sensors to obtain additional information, such as for example, the distance that the earpieces 110-1 and 110-2 are apart. This additional information may be used to estimate the distance between the user's ears. Alternatively, headset 110 may include a sensor to determine the vertical positioning of earpieces 110-1 and 110-2 to estimate the position of the user's left and right ears with respect to the user's head.

The head size data from headset 110 may be forwarded to user device 112. In other implementations, headset 110 may forward “raw” head size information from sensor 300 and user device 112 may determine the head size and other head size related information based on the received information.

In each case, HRTF analysis logic 710 (FIG. 7) may receive the head size information and identify an appropriate HRTF (block 1020). For example, HRTF analysis logic 710 may identify that the head size is 65 cm (as illustrated in FIG. 3B) and determine that an HRTF for a head size of 65 cm is the appropriate HRTF for the user.

HRTF analysis logic 710 may then determine whether the appropriate HRTF associated with the particular user wearing headset 110 is stored in HRTF database 720 (block 1030). For example, continuing with the example above in which the determined head size is 65 cm, HRTF analysis logic 710 may access HRTF database 720 and identify entry 720-5 as corresponding to a head size of 65 cm (block 1040). In this case, HRTF analysis logic 710 may identify and select HRTF 5 as being the corresponding HRTF associated with the 65 cm head size (block 1040).

Alternatively, if HRTF analysis logic 710 does not identify an appropriate HRTF stored in HRTF database 720 for the user's particular head size (block 1030—no), HRTF analysis logic 710 may generate or augment an existing HRTF stored in HRTF database 720 (block 1050). For example, HRTF analysis logic 710 may modify various parameters associated with one of the HRTFs stored in HRTF database 720 to essentially modify the HRTF for the 65 cm head size. In one implementation, HRTF analysis logic 710 may identify the closest head size to the measured head size and the HRTF corresponding to the closest measured head size. HRTF analysis logic 720 may then transform the closest using, for example, an FEM, FDM, finite volume method, or another numerical method, using the actual measured head size information.

In another implementation, HRTF analysis logic 710 may use the head size information as an input to generate or augment an existing HRTF. For example, an HRTF function stored by HRTF analysis logic 710 may include a head size parameter as an input to generate an HRTF “on the fly” for the user's estimated head size. In this case, HRTF analysis logic 710 and/or signal processing logic 740 may use the measured head size as an input to an HRTF function to generate an HRTF output that is appropriate/customized for the particular user's head size.

Alternatively, HRTF analysis logic 710 may forward the head size information to HRTF device 202. In this case, HRTF generator 910 may generate an HRTF or augment/adapt an existing HRTF based on the received head size information. HRTF generator 910 may forward the generated HRTF to user device 112 via communication logic 920 for storing in HRTF database 720.

In each case, assume that the appropriate HRTF is identified or generated. Signal processing logic 740 may then apply the selected HRTF to the audio source or audio signal to be provided to headset 110 (block 1060). User device 112 may then output the HRTF-modified audio signal to headset 110 (block 1070). That is, user device 112 may output a left ear signal and right ear signal to speakers in ear pieces 110-1 and 110-2 of headset 110. In this manner, the audio signals provided to the right ear and left ear speakers in ear pieces 110-1 and 110-2 are processed in accordance with the selected HRTF.

### CONCLUSION

Implementations described herein provide a customized audio experience by selecting a HRTF based on a user's head size, modifying an existing HRTF based on the user's head size or generating an HRTF based on the user's head size. The HRTF may then be applied to the speakers providing sound to the user's left and right ears to provide realistic sounds that more accurately emulate the originally produced sound. That is, the generated sounds may be perceived by the user as if the sounds were produced by the original sound sources, at specific locations in three dimensional spaces.

The foregoing description of implementations provides illustration, but is not intended to be exhaustive or to limit the implementations to the precise form disclosed. Modifications and variations are possible in light of the above teachings or may be acquired from practice of the teachings.

For example, in the above, user device 112 is described as applying an HRTF to an audio signal. In other implementations, headset 110 may perform these functions. That is, headset 110 may store a number of HRTFs and may also include processing logic to identify and apply one of the HRTFs to the audio signals based on the user's head size information. Headset 110 may then provide the HRTF processed audio signals to the left ear and right ear speakers.

In addition, features have been mainly described above with respect to over-the ear type headphones that include a sensor 300 that estimates head size based on bending and/or sliding parameters associated with the adjustable headset. In other implementations, neck-band type headphones may be used. In these implementations, the neck-band type headphones may not include any sliding parts and the sensor may measure or estimate the head size based on the degree of bend, strain or deflection associated with the ear phones coupled to the user's ears. As still another example, an eyeglass type device or head mount display worn by a user may include headphones. In these implementations, the degree of bend, strain or deflection of a portion of the eyeglass (e.g., the side pieces of the eyeglasses) worn by the user may be used to estimate the head size of the user.

Further, features have been described above mainly with respect to measuring/estimating head size (e.g., circumference, diameter, etc.). In some implementations, head shape estimations, ear location estimations, etc., may also be used, or may be used to augment the head size information when identifying an appropriate HRTF for the user. In these implementations, HRTF database 720 may include additional head-related information. As an example, field 810 in HRTF database 720 (or another field in HRTF database 720) may include relative ear height information, head shape information (e.g., round, egg-like, long, narrow, etc.). HRTFs corresponding to these different head related parameters (e.g., shape, size, etc.) may also be stored in HRFT database 720 to allow for HRTFs that are more tailored/customized to the different users.

Still further, features have been described above with respect to dynamically measuring head size and selecting an HRTF based on the measured head size. In other implementations, user device 112 may provide a user interface that allows the user to select his/her particular head size. For example, user device 112 may include a graphical user interface (GUI) that outputs information to a user via output device 650 (e.g., a liquid crystal display (LCD) or another type of display). The GUI may prompt the user to enter his/her head size (e.g., small, medium large, a particular size in centimeters or inches, etc). HRTF analysis logic 710 may receive the selection and select an appropriate HRTF from HRTF database 720 based on the user-provided information. Such an implementation may be useful in situations where the headphones do not include any head size measuring sensors.

In addition, features have been described above with respect to FIG. 10 as determining whether an appropriate HRTF is stored in user device 112, prior to generating a new HRTF or augmenting/modifying an existing HRTF. In other implementations, user device 112 or headset 110 may generate a new HRTF or modify an existing HRTF based on the head size information, without checking whether an HRTF is stored in user device 112. For example, in some implementations, user device 112 may not include pre-stored HRTFs. In such implementations, HRTF analysis logic 710 and/or processing 740 in user device 112 (or headset 110) may generate a HRTF based on the user's head size in a real-time or near real-time manner.

It will also be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, although details of generating HRTFs based on the particular head sizes is not described in detail herein, any number of methods of generating the customized HRTFs may be used.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
determining a user's head size;
forwarding information associated with the user's head size to a processing device;
at least one of:
identifying, by the processing device, a head-related transfer function (HRTF) associated with the user's head size, or
modifying, by the processing device, a HRTF based on the user's head size;
applying the identified HRTF or modified HRTF to audio signals to produce output signals; and
forwarding the output signals to first and second speakers.

2. The method of claim 1, wherein the at least one of identifying or modifying comprises identifying a HRTF associated with the user's head size, wherein the identifying comprises:
accessing a memory storing a plurality of HRTFs, and
identifying a first one of the plurality of HRTFs corresponding to the user's head size.

3. The method of claim 2, wherein the memory is configured to at least one of:
store HRTFs corresponding to a small head size, a medium head size and a large head size,
store HRTFs corresponding to a plurality of different head circumferences, or
store HRTFs corresponding to a plurality of different head diameters.

4. The method of claim 1, further comprising:
determining a second user's head size;
forwarding information associated with the second user's head size to the processing device; and
accessing the memory to determine whether one of the plurality of HRTFs corresponds to the second user's head size.

5. The method of claim 4, further comprising:
at least one of generating a HRTF based on the second user's head size, in response to determining that none of the plurality of HRTFs corresponds to the second user's head size, or
modifying one of the plurality of HRTFs based on the second user's head size, in response to determining that none of the plurality of HRTFs corresponds to the second user's head size.

6. The method of claim 1 wherein the determining a user's head size comprises:
estimating, by a sensor located on a headset worn by the user, the user's head size.

7. The method of claim 6, wherein the estimating comprises:
measuring, by the sensor, a strain or degree of bend of a portion of the headset.

8. The method of claim 1, further comprising:
determining the user's ear positions, and wherein the identifying a HRTF further comprises:
identifying the HRTF based on the user's ear positions.

9. The method of claim 1, further comprising:
providing a user interface for receiving an input for selecting one of a plurality of head sizes;
selecting an HRTF corresponding to the selected head size; and
applying the selected HRTF to audio signals to be output to first and second speakers.

10. The method of claim 1, wherein the determining a user's head size is performed by at least one of a headset device, a neckband device, an eyeglass device or a headphones device.

11. A device, comprising:
a memory configured to store a plurality of head-related transfer functions (HRTFs), each of the HRTFs being associated with a different head size; and
processing logic configured to:
receive head size information associated a user,
at least one of identify a first HRTF associated with the received head size information, generate a first HRTF based on the received head size information, or modify an existing HRTF to provide a first HRTF based on the received head size information, and
apply the first HRTF to audio signals to produce output signals; and
a communication interface configured to forward the output signals to first and second speakers configured to provide sound to the user's left and right ears.

12. The device of claim 11, wherein the plurality of HRTFs includes at least HRTFs corresponding to a small head size, a medium head size and a large head size.

13. The device of claim 11, wherein the processing logic is further configured to:
receive head size information associated with a second user, and
determine whether one of the plurality of HRTFs stored in the memory corresponds to the second user's head size.

14. The device of claim 13, wherein the processing logic is further configured to:
at least one of generate a HRTF based on the second user's head size, in response to determining that none of the plurality of HRTFs corresponds to the second user's head size, or
modify one of the plurality of HRTFs based on the second user's head size, in response to determining that none of the plurality of HRTFs corresponds to the second user's head size.

15. The device of claim 11, wherein the communication interface is configured to receive the plurality of HRTFs from an external device, and the processing logic is configured to store the HRTFs received from the external device in the memory.

16. The device of claim 11, further comprising:
a headset comprising the first and second speakers.

17. The device of claim 11, wherein the device comprises a mobile terminal.

18. A device comprising:
a right ear speaker;
a left ear speaker;
at least one sensor configured to measure at least one parameter associated with a user of the device; and
a processor configured to:
estimate head size of the user based on the at least one parameter, and
forward head size related information to a processing device to identify a head related transfer function (HRTF) to apply to audio signals provided to the right ear speaker and left ear speaker.

19. The device of claim 18, wherein the at least one sensor is configured to measure a degree of strain, bend or deflection exerted on a portion of the device.

20. The device of claim 18, further comprising:
the processing device, wherein the processing device is configured to at least one of:
identify the HRTF from a plurality of HRTFs based on the head size related information,
generate the HRTF based on the head size related information, or
modify an existing HRTF to provide the HRTF based on the head size related information.
